(19) United States
(12) Patent Application Publication
(10) Pub. No.: US 2011/0213672 A1
(43) Pub. Date: Sep. 1, 2011

(54) SYSTEM AND METHOD FOR MANAGING A PARKING LOT

(75) Inventors: William Gibbens Redmann, Glendale, CA (US); Chris Outwater, Santa Barbara, CA (US)

(73) Assignee: Liberty Pluglns, Inc.

(21) Appl. No.: 13/104,309

(22) Filed: May 10, 2011

Related U.S. Application Data
(63) Continuation-in-part of application No. 12/957,348, filed on Nov. 30, 2010.
Application No. 12/957,348 is a continuation-in-part of application No. 12/659,666, filed on Mar. 16, 2010.
Application No. 12/659,666 is a continuation-in-part of application No. 12/659,376, filed on Mar. 5, 2010.
(60) Provisional application No. 61/265,440, filed on Dec. 1, 2009.
(60) Provisional application No. 61/252,909, filed on Oct. 19, 2009.
(60) Provisional application No. 61/332,875, filed on May 10, 2010.

(51) Int. Cl. G06Q 50/00; G06F 17/00

(52) U.S. Cl. 705/24; 705/418

(57) ABSTRACT

A system and method for managing a parking lot where different parking spaces have associated logical attributes that determine pricing for using that space. Typical attributes are “Last Space”, “One of Last Spaces” or “Safe Space”. Other non-premium spaces can simply have an attribute of “Ordinary” or the like. As ordinary spaces are used up, motorists may become motivated to pay higher fees to park in the last remaining spaces or premium spaces. Also, safe spaces that provide additional protection for a vehicle may go at a premium price. The present invention works at both gated and ungated lots. With an ungated lot, a ticket can be printed displaying the fact that the vehicle has paid a premium (or ordinary) rate. With a gated lot, some of the spaces can be further gated as premium or discount spaces that go at a corresponding higher or lower price.

### CROSS-REFERENCE TO RELATED APPLICATION

This application is a continuation-in-part application of U.S. patent application Ser. No. 12/957,348 (hereinafter the “'348 application”), filed Nov. 30, 2010, which claims the benefit of U.S. Provisional Patent Application No. 61/265,440, filed Dec. 1, 2009, the '348 application is a continuation-in-part application of U.S. patent application Ser. No. 12/659,666 (hereinafter the “'666 application”), filed Mar. 16, 2010, the '666 application is a continuation-in-part application of U.S. patent application Ser. No. 12/659,376 (hereinafter the “'376 application”), filed Mar. 5, 2010, the '376 application claims the benefit of U.S. Provisional Patent Application No. 61/252,909, filed Oct. 19, 2009, and this application claims the benefit of U.S. Provisional Patent Application No. 61/332,875, filed May 10, 2010. All of the above mentioned applications have common inventorship with the present application and are incorporated by reference herein in their entireties.

### BACKGROUND

1. Field of the Invention

The present invention relates generally to the field of automated parking lot management and more particularly to a system and method dealing with high-demand parking where particular parking spaces have attributes such as “last space” or “one of the last spaces” that can be used to maximize revenue.

2. Description of the Problem

Many parking lots today are automated or partially automated. Some of these lots have entry and exit kiosks, while many others are simply open lots for surface parking. There is considerable interest in maximizing revenue in both on-street and off-street parking based on supply and demand. If there is a limited supply of spaces that are in demand, the lot operator should be able to raise the price for those spaces. On the other hand, if there are numerous empty spaces and/or low demand, the operator may want to lower the price per space to encourage usage.

A major problem in such lots is how to automatically and efficiently determine level of occupancy when there is no attendant. One proposed method is to place occupancy sensors on each parking spot. This has several drawbacks, namely it is very expensive, and these numerous sensors must be constantly maintained including keeping them clean and frequently making sure each is functioning and reporting to a central processing unit that can take the information and act accordingly. A second proposed method is to utilize statistical analysis of parking operations based on location, time of day, past frequency of turnover of that area, and similar methods. If the lot has automated entry and exit stations, it is easy to know the gross total number of cars in the lot. This is also true with a manual pay exit station coupled to an automatic ticket dispensing at entry. One drawback is that in a system with just entry and exit count, it is impossible to know how long a particular vehicle will remain in the lot. As stated, predictions can be made based on known statistics, but there still remains a high level of uncertainty of how much many parking spaces are available at any time. Open air, or surface parking lots may have even more difficulty predicting occupancy rates and how long vehicles will remain.

It would be advantageous to have a way of maximizing the amount that can be charged for a parking space in a high demand area without a major investment in sensors or other hardware installations, and without major software development and the computer to do the calculations. The method and system of the present invention can be based on the concept that a particular parking space in a lot can have an associated attribute that is logically connected with the space and can be managed automatically.

### SUMMARY OF THE INVENTION

The present invention relates to a system and method for automatically managing a parking lot that can maximize the amount the operator or owner can charge for a parking space based on that parking space having an associated logical attribute. Attributes can be “Ordinary space”, “One of Last Available Spaces”, “Last Available Space”, “Safe Space” and any other logical attribute that can be associated with a parking space. The '376 application and the '666 application discuss and present the concept of some parking spaces in a lot having the attribute of being electric vehicle charging spaces and thus introduce the concept of logical attributes being associated with parking spaces.

In the case of a parking space with an attribute such as “Last Remaining”, the provider can raise the price for that (or those) space(s). There can be very clear signage that this space, or these remaining spaces, is (are) the last remaining space(s) available for rent, and that these particular spaces carry a premium charge because they are scarce. A “Safe” space can be a space that reduces the danger to a car from being scratched or dinged by nearby cars. Any of these premium spaces can be, but do not necessarily have to be, located in more desirable locations such as near exits or elevators.

Because these particular designated spaces carry a premium price, they will usually not be occupied as long as there are cheaper spaces available (at least on the average). As the cheaper spaces run out, consumers are more likely to choose to park in the more expensive spaces. However, the consumer will also be free to leave that location and seek a non-premium parking space in another lot or on another street.

### DESCRIPTION OF THE DRAWINGS

Attention is now directed to several figures that illustrate features of the present invention:

FIG. 1 shows an open or ungated parking lot with premium spaces.

FIG. 2 shows a gated parking lot with premium spaces.

FIG. 3 shows an ungated lot with a vehicle entering a “safe” space.

FIGS. 4A, 4B and 4C show samples of tickets that can be provided for both regular and premium parking spaces.

FIG. 5 shows a block diagram of a smart kiosk.

FIG. 6 shows a bus arrangement for managing a system of ungated parking lots.

FIG. 7 shows a bus arrangement for managing a system of gated parking lots.

FIG. 8 shows attribute types and rules associated with attributes.

FIG. 9 is an exemplary flowchart showing a method for calculating a parking lot parking fee, in accordance with various embodiments.

FIG. 10 is a schematic diagram showing a system for calculating a parking lot parking fee, in accordance with various embodiments.

FIG. 11 is a schematic diagram of a system that includes one or more distinct software modules that performs a method for calculating a parking lot parking fee, in accordance with various embodiments.

Several drawings and illustrations have been presented to aid in understanding the present invention. The scope of the present invention is not limited to what is shown in the figures.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

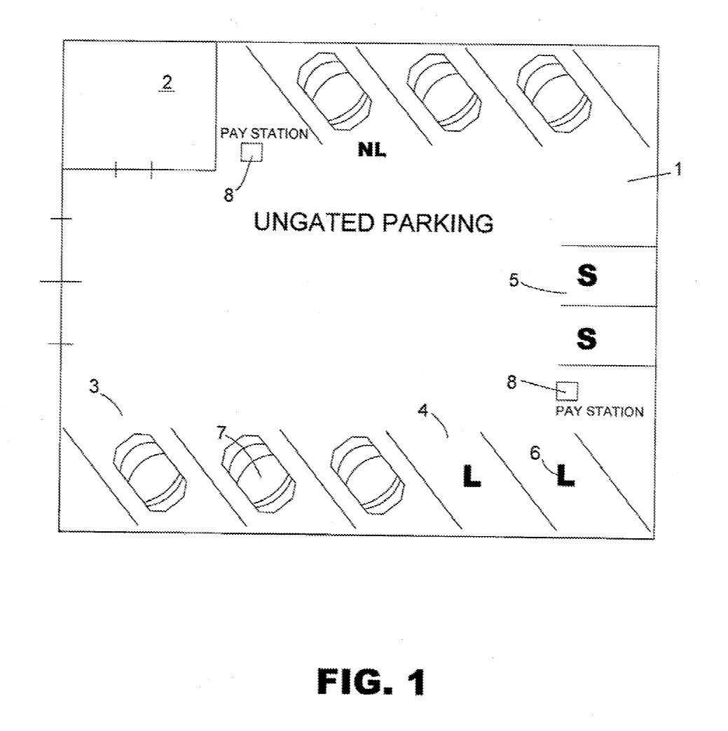

Turning to FIG. 1, a diagram of an ungated or open parking lot 1 can be seen. The lot may have one or more entrances/exits that are unguarded. A passing motorist can generally see how full the lot is before entering. The lot 1 may have an office or elevator 2, or it may simply be an open space. Vehicles 7 are shown parked in various spaces. An ordinary (non-premium) space 3 is shown along with a premium space 4. The premium spaces contain well-marked labels 6 that show their attribute. In addition, signage is posted on all premium spaces to explain the cost and any other restrictions to the premium space. Pay stations 8 can be conveniently located on the lot.

A typical embodiment of the present invention at an ungated lot is to have the motorist choose a parking place according to signage (ordinary or premium), walk to the pay station 8 and either enter the number of the space or simply indicate what type of space was chosen. One option can be to indicate that the motorist has parked in a premium lot with the “last space” attribute. Payment is generally made at that time, the price being determined by what type of space was chosen. In the case of numbered spaces for the “pay by space” method, the pay station will know, based on the space number, what attributes, if any, that specific space has. The transaction is completed, and the motorist can walk off the lot, knowing that he/she has paid the proper amount for parking and will not be cited for a parking infraction. If spaces are not numbered, then the pay station will be using the “pay and display” method. In this case, the pay station 8 can print a ticket with an indicator, such as a symbol or letter or code that shows the type of space on it. The ticket is then displayed in the vehicle before the motorist departs the lot. The latter method depends on the motorist knowing that there will be lot enforcement during the stay, and that a vehicle displaying an expired ticket, or the wrong ticket for the attributes of the parking space they are occupying, (or no ticket at all) will be cited.

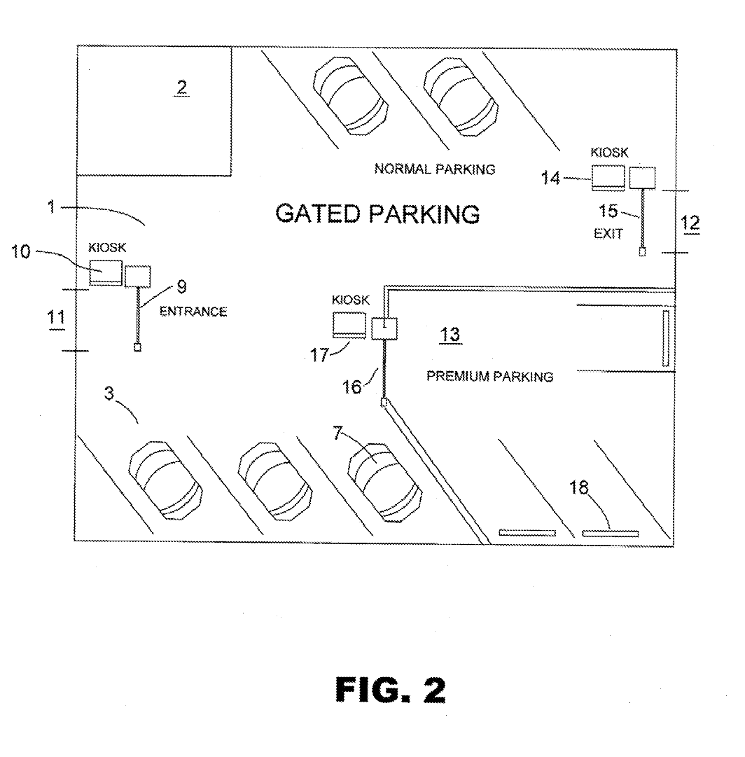

FIG. 2 shows an embodiment of the present invention with a gated lot. In this case, there is an entrance 11, with a gate 9, an exit 12 with another gate 15, and a restricted area or premium area 13 with still another gate 16. Each of the gates can also have a kiosk 10, 14 and 17. The premium area 13 has signage at the gate 18 and perhaps additional signs on each space (easily visible) that clearly explains that a premium price will be charged for parking in that area. When a motorist enters the lot 1, he or she is free to drive around and look for an ordinary space 3, and to park if one is found. The entry kiosk 10 issues a ticket, and the entry gate 9 opens. Depending on the lot owner's policy, when the ticket is presented to exit kiosk 14, the motorist may be given a grace period of 0-20 minutes to exit the lot through the exit gate 15 with no payment at all. If the motorist cannot find an ordinary space, signage can clearly indicate that entry can be made into the premium area 13 by simply inserting the same ticket into the premium entry kiosk 17. The premium entry kiosk 17 can modify the ticket to show that parking occurred in the premium area, or alternatively the kiosk 17 can simply modify a database that tracks the status of active tickets. Again, the motorist will be informed, either by signage or by the kiosk, that higher prices will be charged. Exit from the premium area can be made simply by opening the gate 16 with a sensor whenever a vehicle wishes to exit, or through a one-way exit (not shown). Again, if upon presenting the ticket to kiosk 14, the policy may be that if the motorist is within the grace period, no charge is made at the exit 12. If, on the other hand, the grace period has been exceeded, the exit kiosk 14 will charge the premium price before opening the exit gate 15.

To handle the case where the motorist enters the premium area and then changes his or her mind and decides to park in an ordinary space instead (for example one opens up after the driver is in the premium area), an optional second kiosk can be used to downgrade the ticket back to a regular state as the premium area 13 is exited.

In an alternative embodiment, the premium parking can be near the street entrance, and a secondary gate leads to cheaper parking perhaps on higher or lower levels. In this case, the motorist can pay a premium price to be at street level or near a convenient entrance or exit.

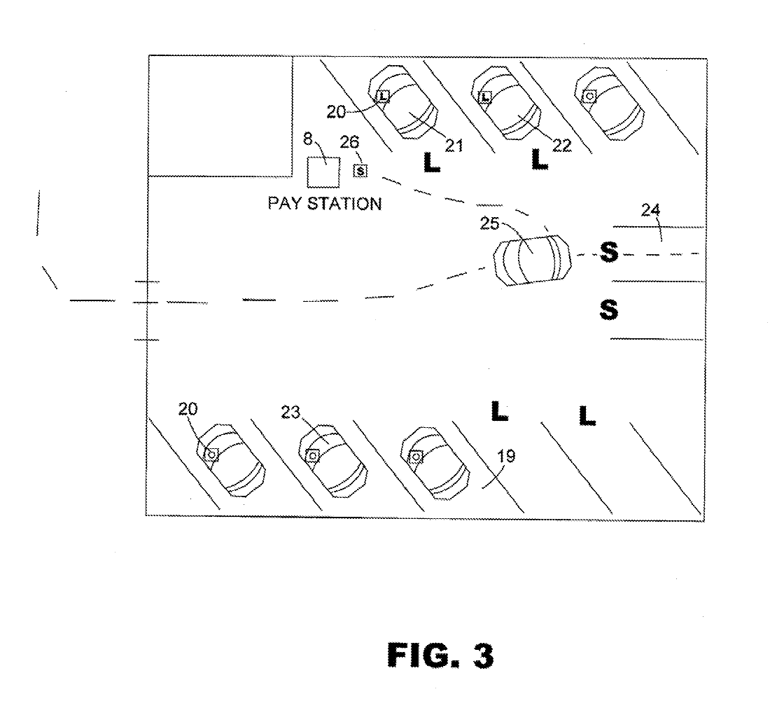

FIG. 3 shows an ungated type lot with a pay station 8 that prints tickets 20 that are placed inside driver's side window or windshield of vehicles. The vehicles in L type premium spaces can have a ticket 20 that displays a large L for example. Vehicles 23 parked in ordinary spaces 19 can have tickets with some other symbol like O, or no special symbol at all. FIG. 3 also shows a vehicle 25 entering the lot and choosing a “Safe” spot 24. After parking, the driver can walk to the pay station 8, indicate the choice of a premium space, pay for it, and then receive a ticket 26 that displays an S for example. The driver then must place that ticket in the vehicles windshield or on the dashboard.

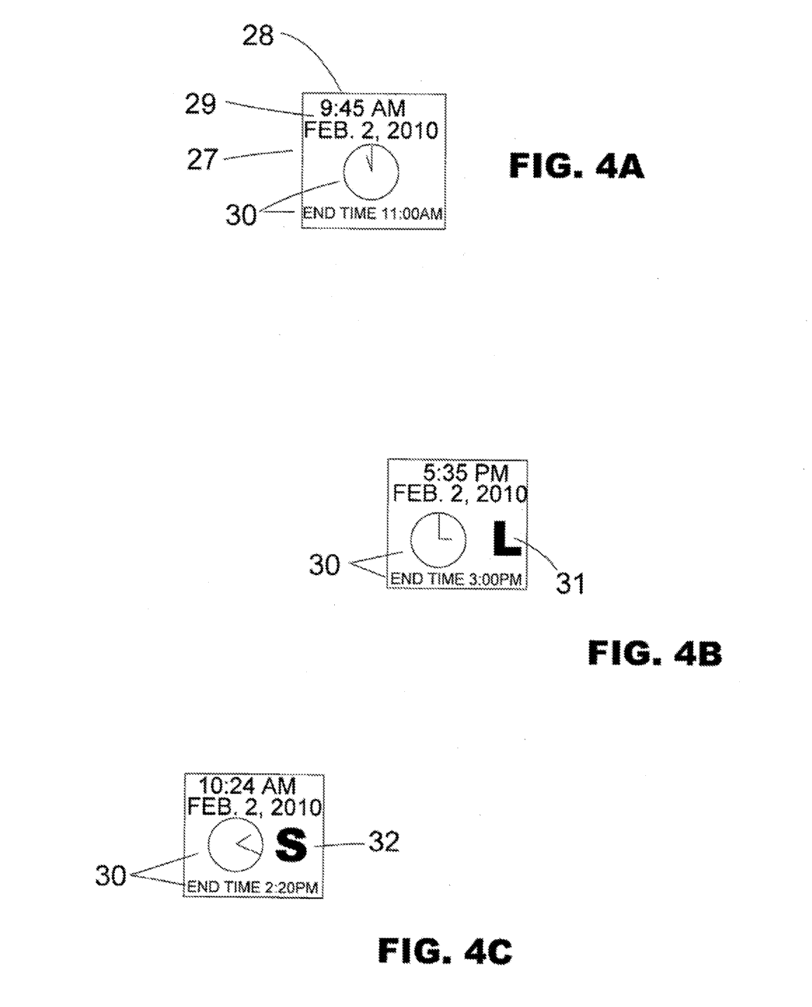

FIGS. 4A-4C show different types of tickets that could be printed. FIG. 4A shows a standard, or ordinary, ticket 28 that may or may not contain a symbol. Alternatively, this ticket, or any of the tickets, can contain a clock symbol 30 and indication of the ending time if there is one. The ticket 28 can have an entry time 29, date 27 and any other necessary information. FIG. 4B shows a ticket for a space with an L attribute 31, while FIG. 4C shows a ticket with an S attribute 32. These also have optional ending times 30. It should be understood that many different attributes can be associated with a parking space and many types of letter or symbols can be printed on the ticket.

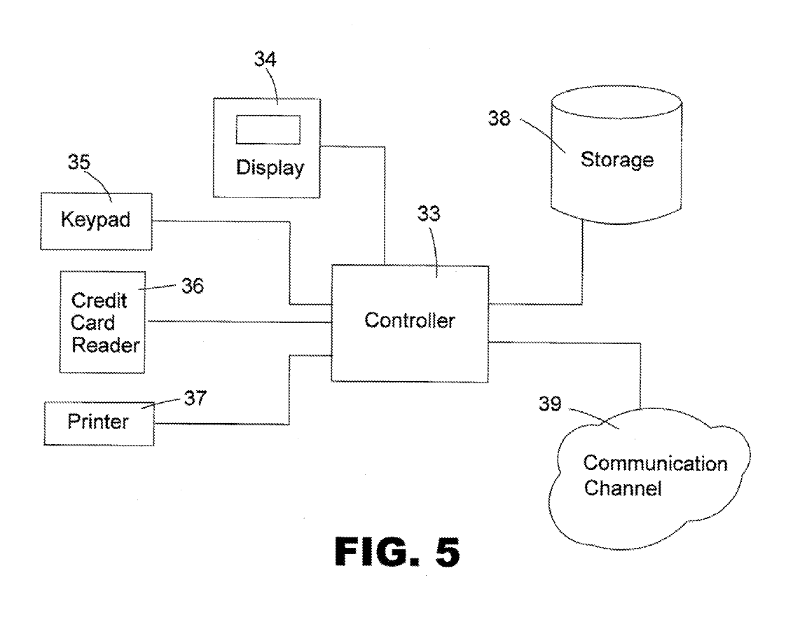

FIG. 5 shows a block diagram of a kiosk or pay station that could be used in any type of lot. A controller 33 or processor is coupled to storage 38 and a communication channel 39 that can be wired or wireless. Wireless links can be WiFi, cellular or any other type of wireless link. Communications can be by private network or via the Internet. The station optionally has a keypad 35 and a display 34 that can be used to select options or present information concerning ordinary and premium parking spaces. The station may have a credit card reader 36 if it is an exit or pay station. The station can also have a printer 37 for printing tickets and/or receipts.

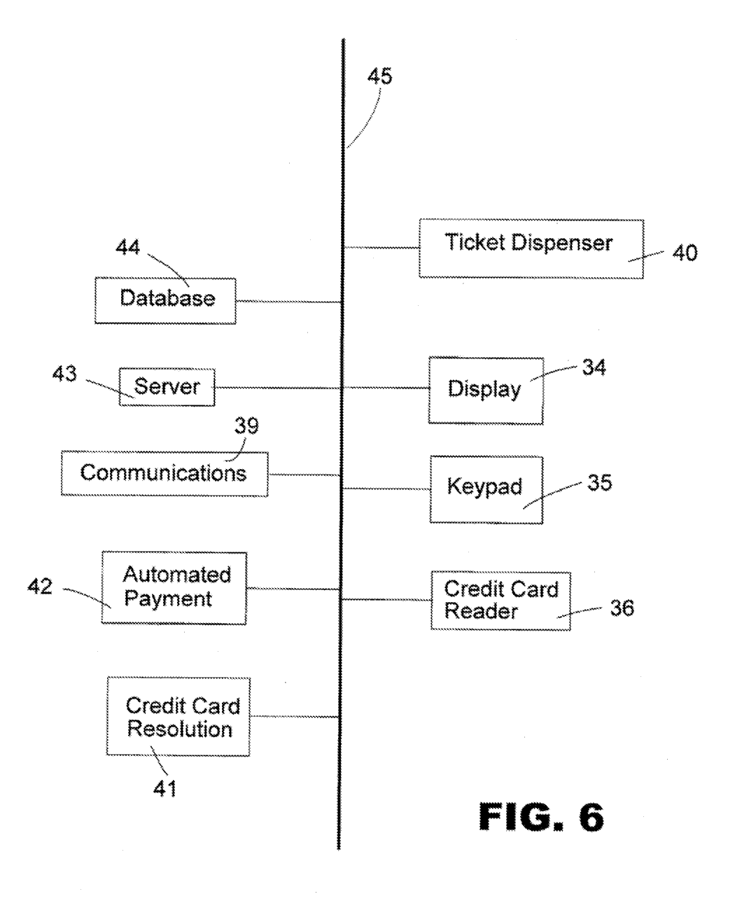

FIG. 6 shows a parking lot system on an associated bus 45. This bus 45 may span multiple stations and may be partially remote from the parking lot. The bus 45 may have access to one or more databases 44 containing pricing rules, statistical information, and user information for periodic users or regular customers who are billed monthly. The bus may be driven by one or more servers 43 that may be located completely remotely and may manage several lots. FIG. 6 shows a single ticket dispenser 40, display 34, keypad 35 and credit card reader 36. However, it is to be understood that these can represent multiple units physically located on different lots or separated in the same lot. The bus can accept automated payment 42 from regular users and can perform credit card resolution 41 by communicating 39 with remote services.

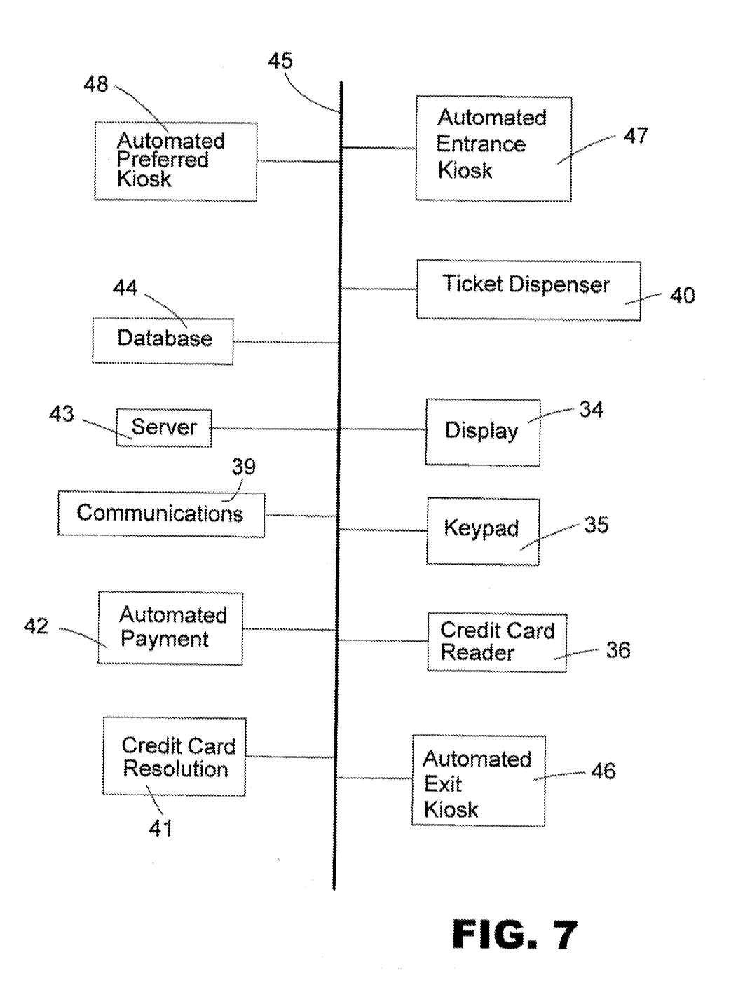

FIG. 7 shows the bus of FIG. 6 with additional services such as automated entrance kiosks 47, preferred area kiosks, 48 and automated exit kiosks 46 that can be used in gated lots. It should be noted that a single bus system 45 can manage a combination of both gated and ungated lots.

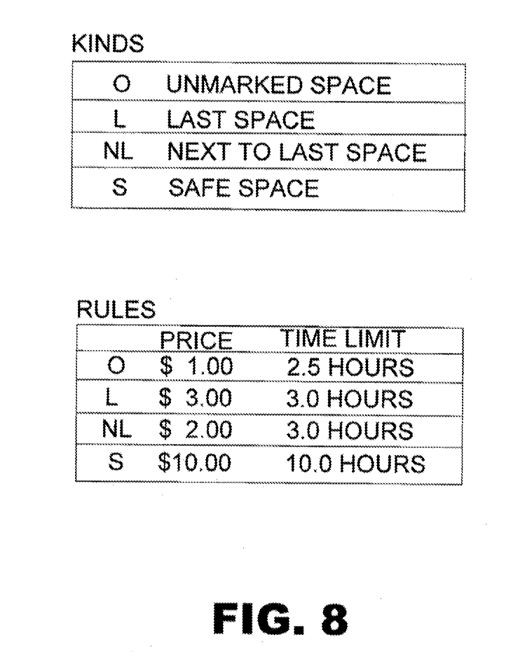

FIG. 8 shows a table of possible attributes or kinds of parking spaces such as O, L, NL and S as well as a possible set of rules for pricing and timing use of parking spaces with these attributes. Any number or type of attributes, and any number and types of rules associated with the attributes, is within the scope of the present invention.

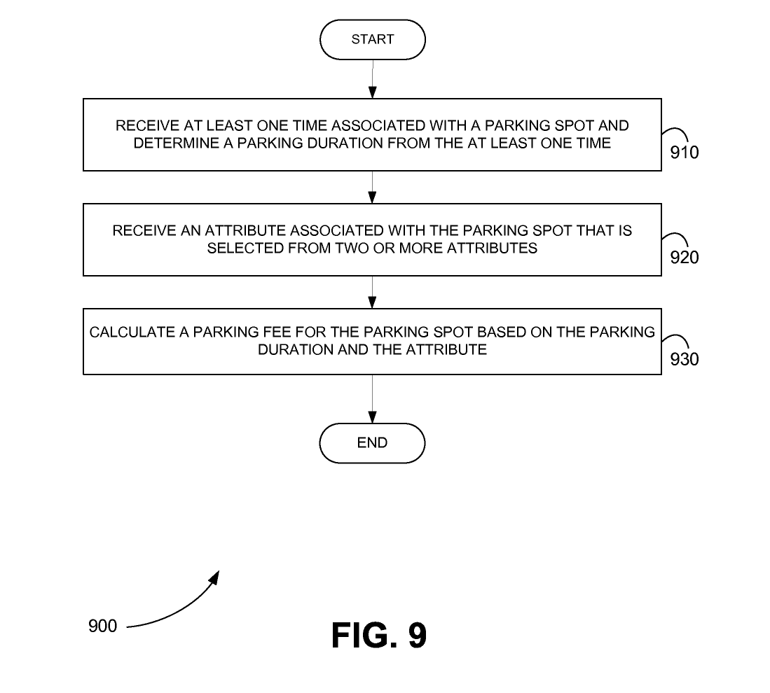

FIG. 9 is an exemplary flowchart showing a method 900 for calculating a parking lot parking fee, in accordance with various embodiments.

In step 910 of method 900, at least one time associated with a parking spot is received and a parking duration is determined from the at least one time.

In step 920, an attribute associated with the parking spot is received that is selected from two or more attributes.

In step 930, a parking fee for the parking spot is calculated based on the parking duration and the attribute.

In various embodiments, the attribute can include, but is not limited to, an ordinary space attribute, a one of last available spaces attribute, a last available space attribute, or a safe space attribute.

In various embodiments, the steps of method 900 are performed by a pay station. The at least one time received by the pay station is the parking duration, for example. The pay station receives the parking duration from a user through a keypad, for example. The determination of the parking duration is then equating the parking duration to the received parking duration. In various embodiments, the pay station can determine the current time, receive a projected exit time, and determine the parking duration from the current time and the projected exit time. The pay station receives the projected exit time from a user through a keypad, for example. The pay station receives the attribute, and calculates the parking fee from the attribute and the parking duration.

In various embodiments, the pay station receives the attribute through a parking space number. The pay station receives the parking lot space number for the parking space, searches a database, and retrieves an attribute stored in the database for the parking space number using the pay station. The database can include hardware and software. The database can be, but is not limited to, a magnetic or electronic storage medium.

In various embodiments, the pay station receives the attribute through input provided by a user. The pay station receives a parking space type selection for the parking space, searches a database, and retrieves an attribute stored in the database for the parking space type using the pay station.

In various embodiments, the pay station can be part of a pay and display parking system. The pay station further prints on a parking ticket a symbol that indicates the parking space type selection.

In various embodiments, the steps of method 900 are performed by an exit kiosk. The at least one time that is received is an entry time, for example. The exit kiosk receives the entry time, determines an exit time, and determines the parking duration from the entry time and the exit time. The exit kiosk receives the attribute, and calculates the parking fee for the parking spot from the attribute and the parking duration.

In various embodiments, exit kiosk receives the attribute from a parking ticket. The exit kiosk receives a parking ticket modified by a premium area kiosk to include the attribute. The exit kiosk reads the attribute from the parking ticket. The premium area kiosk can be a premium area entry kiosk or a premium area exit kiosk.

In various embodiments, the exit kiosk determines the attribute from a parking ticket identifier. The exit kiosk receives the parking ticket. The exit kiosk reads a parking ticket identifier from the parking ticket, searches a database, and retrieves from the database the attribute stored with the ticket identifier by a premium area kiosk. The premium area kiosk can be a premium area entry kiosk or a premium area exit kiosk.

In various embodiments, an attribute can identify a location of the parking spot in the parking lot. The attribute can identify proximity to an entrance or a level of the parking lot, for example.

In various embodiments, calculating a parking fee based on the parking duration and the attribute can include retrieving a rule associating a price with parking duration and the attribute, and calculating the parking fee based on the rule.

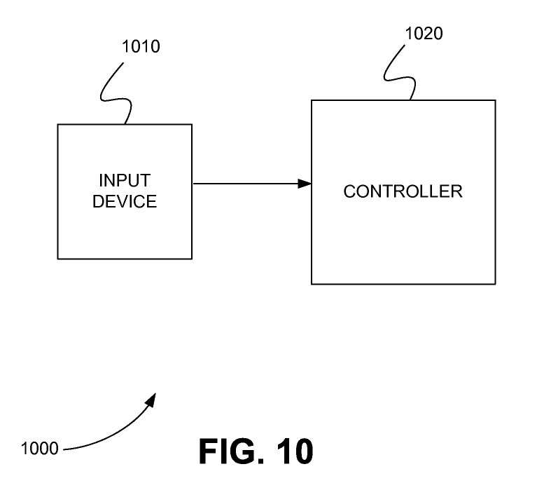

FIG. 10 is a schematic diagram showing a system 1000 for calculating a parking lot parking fee, in accordance with various embodiments. System 1000 includes input device 1010 and controller 1020. If system 1000 is part of a pay station of an ungated lot, input device 1010 is an input device for a user, such as a keypad, and controller 1020 is a controller of the pay station, for example. If system 1000 is part of an exit kiosk of an gated lot, input device 1010 is an input device, such as a parking ticket reader, and controller 1020 is a controller of the exit kiosk, for example.

Input device 1010 receives at least one time associated with a parking spot and determines a parking duration from the at least one time. Input device 1010 receives an attribute associated with the parking spot that is selected from two or more attributes. Controller 1020 calculates a parking fee for the parking spot based on the parking duration and the attribute.

In various embodiments, a computer program product includes a non-transitory and tangible computer-readable storage medium whose contents include a program with instructions being executed on a controller so as to perform a method for calculating a parking lot parking fee. This method is performed by a system that includes one or more distinct software modules. A controller can include, but is not limited to a computer, a microprocessor, a microcontroller, an application specific integrated circuit, a field programmable gate array, or any device capable of executing instructions and/or sending and receiving control signals.

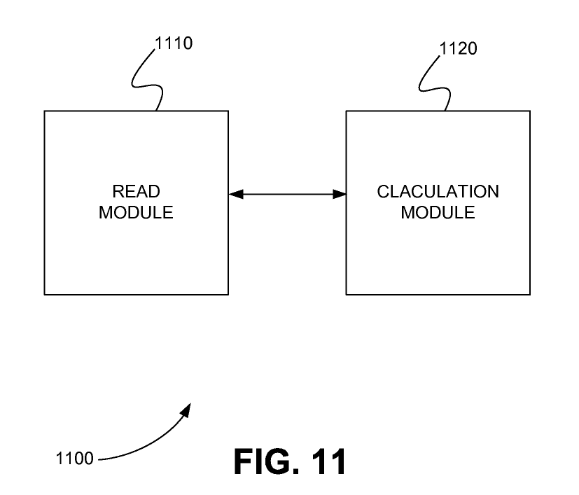

FIG. 11 is a schematic diagram of a system 1100 that includes one or more distinct software modules that performs a method for calculating a parking lot parking fee, in accordance with various embodiments. System 1100 includes read module 1110 and a calculation module 1120.

Read module 1110 receives at least one time associated with a parking spot and determining a parking duration from the at least one time. Read module 1110 receives an attribute associated with the parking spot that is selected from two or more attributes. Calculation module 1120 calculates a parking fee for the parking spot based on the parking duration and the attribute.

Several descriptions and illustrations have been presented that aid in understanding the features of the present invention. One skilled in the art will realize that numerous changes and variations are possible without departing from the spirit of the invention. Each of these changes and variations is within the scope of the present invention.

Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. For example, while many of the foregoing embodiments used a relational database paradigm because of its efficient and clear illustrative qualities, those skilled in the art will recognize that other data organizations and other software techniques can be used to achieve the results of the present invention. Thus, while preferred embodiments of the present invention have been disclosed, it will be appreciated that it is not limited thereto but may be otherwise embodied within the scope of the following claims.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for calculating a parking lot parking fee, the method comprising:
receiving at least one time associated with a parking spot and determining a parking duration from the at least one time;
receiving an attribute associated with the parking spot that is selected from two or more attributes; and
calculating a parking fee for the parking spot based on the parking duration and the attribute.

2. The method of claim 1, wherein the attribute comprises an ordinary space attribute.

3. The method of claim 1, wherein the attribute comprises a one of last available spaces attribute.

4. The method of claim 1, wherein the attribute comprises a last available space attribute.

5. The method of claim 1, wherein the attribute comprises a safe space attribute.

6. The method of claim 1, wherein the at least one time comprises the parking duration and a pay station receives the parking duration, receives the attribute, and calculates the parking fee.

7. The method of claim 6, wherein receiving an attribute associated with the parking spot that is selected from two or more attributes comprises
receiving a parking lot space number for the parking space,
searching a database, and
retrieving an attribute stored in the database for the parking space number using the pay station.

8. The method of claim 6, wherein receiving an attribute associated with the parking spot that is selected from two or more attributes comprises
receiving a parking space type selection for the parking space,
searching a database, and
retrieving an attribute stored in the database for the parking space type using the pay station.

9. The method of claim 8, further comprising printing on a parking ticket a symbol that indicates the parking space type selection using the pay station.

10. The method of claim 1, wherein the at least one time comprises an entry time and an exit kiosk receives the entry time, determines an exit time, determines the parking duration from the entry time and the exit time, receives the attribute, and calculates the parking fee.

11. The method of claim 10, wherein receiving an attribute associated with the parking spot that is selected from two or more attributes comprises
receiving a parking ticket modified by a premium area kiosk to include the attribute and
reading the attribute from the parking ticket using the exit kiosk.

12. The method of claim 11, wherein the premium area kiosk comprises a premium area entry kiosk.

13. The method of claim 11, wherein the premium area kiosk comprises a premium area exit kiosk.

14. The method of claim 10, wherein receiving an attribute associated with the parking spot that is selected from two or more attributes comprises
receiving a parking ticket,
reading a parking ticket identifier from the parking ticket,
searching a database, and
retrieving from the database the attribute stored with the ticket identifier by a premium area kiosk using the exit kiosk.

15. The method of claim 14, wherein the premium area kiosk comprises a premium area entry kiosk.

16. The method of claim 14, wherein the premium area kiosk comprises a premium area exit kiosk.

17. The method of claim 1, wherein the attribute identifies proximity to an entrance or a level of the parking lot.

18. The method of claim 1, wherein calculating a parking fee based on the parking duration and the attribute comprises retrieving a rule associating a price with parking duration and the attribute and calculating the parking fee based on the rule.

19. A system for calculating a parking lot parking fee, the method comprising:
an input device that receives at least one time associated with a parking spot and determines a parking duration from the at least one time and receives an attribute associated with the parking spot that is selected from two or more attributes; and
a controller that calculates a parking fee for the parking spot based on the parking duration and the attribute.

20. A computer program product, comprising a non-transitory and tangible computer-readable storage medium whose contents include a program with instructions being executed on a controller so as to perform a method for calculating a parking lot parking fee, the method comprising:
providing a system, wherein the system comprises one or more distinct software modules, and wherein the distinct software modules comprise a read module and a calculation module;
receiving at least one time associated with a parking spot and determining a parking duration from the at least one time using the read module;
receiving an attribute associated with the parking spot that is selected from two or more attributes using the read module; and
calculating a parking fee for the parking spot based on the parking duration and the attribute using the calculation module.
